(19) United States
(12) Patent Application Publication
(10) Pub. No.: US 2003/0020747 A1
(43) Pub. Date: Jan. 30, 2003

(54) User input peripheral device substitution for web commerce delivery

(76) Inventor: Aravinda Korala, Edinburgh (GB)

Correspondence Address: SALTAMAR INNOVATIONS, 30 FERN LANE, SOUTH PORTLAND, ME, 04106, US

(21) Appl. No.: 09/915,872

(22) Filed: Jul. 26, 2001

(51) Int. Cl. G09G 5/00

(52) U.S. Cl. 345/744; 345/760; 345/746

(57) ABSTRACT

Self-service kiosk software for use in submitting web forms intended for completion by one type of user input device not provided on the kiosk using an alternative input device. Typically, the kiosk recognized an identifying device, such as a credit or smart card, held by the user. Enables a web form requiring alphanumeric information such as a credit card number to be completed on a self-service kiosk lacking a keyboard and having a credit card reader instead.

### FIELD OF INVENTION

The invention relates to the field of delivering web commerce through self-service kiosks and, more particularly, to delivery of service using software and/or hardware available to said kiosk.

### BACKGROUND TO THE INVENTION

Many e-commerce applications require a user to identify themselves or provide confidential information, such as their name, address and credit card number, to a server. The most common method at the present time for the submission of such information by PC users is by means of hypertext mark-up language (HTML) forms.

In this model, a web server provides a web page to a user's PC in a markup language such as HTML, DHTML or XML. The web page defines various fields of information that are to be supplied by the user and also layout information. Fields include text, numbers, selectable tick boxes, menu items and other input categories. A web browser executes the web page, displaying an image and laying out the form in the specified layout. The web browser then responds to user input completing elements of the form: for example, the person may type in text or use point-and-click to select tick boxes, radio buttons etc. Finally, a user selects a submit button and the information supplied by the user for each field is concatenated into a string of specified format and submitted to the server where it is analysed, for example with the common gateway interface standard.

Self-service kiosks are popular devices for enabling users to access e-commerce services. Self-service kiosks are networked computing devices designed for use by multiple users in carrying out self-contained operations. Examples of self-service kiosks are automatic teller machines (ATMs), public internet access terminals, credit card operated pre-paid ticket collection terminals, networked ticketing machines and computerised vending machines. These are designed for operation by multiple users and each user's interaction with the kiosk is a separate self-contained session. Home computers are not kiosks because users make open ended changes to such computers; however, they can emulate kiosks and personal computers can also control kiosks. The invention can also be applied to interactive televisions having the facilities to emulate kiosks, for example, user identifier means such as a smart card reader.

Self-service kiosks are provided with various different hardware and software configurations. Many of these devices do not have all the peripherals required to access everyday e-commerce websites designed for use with PCs. For example many kiosks do not have a keyboard, because a keyboard can readily be damaged and some members of the public find keyboards slow to use. This leads to a problem when it is desirable to provide a website designed for PC users through a self-service kiosk.

A first aim of the present invention is to enable self-service kiosks to allow easy use of web sites having forms which would usually require input using peripherals not present on the self-service kiosk. A particular aim is to enable a kiosk to be provided which, although it does not have a keyboard, nevertheless allows the user to input information with alphanumeric content.

At the present time, delivery of e-commerce through self-service kiosks is often achieved by rewriting or custom designing web pages specifically for use by self-service kiosks and adapted for use with peripherals provided on the particular self-service kiosks. A further aim of the present invention is to allow a single web page to be operated conveniently through self-service kiosks, home PCs and other networked computing devices having different input peripherals. Advantageously, web forms designed for completion on home PCs might be operated on self-service kiosks without any additional work by, or even the participation of, the web form provider.

### BRIEF DESCRIPTIONS OF THE INVENTION

According to a first aspect of the present invention there is provided a self-service kiosk adapted to submit data to a data receiving server in a data format, the system comprising:

a data retrieval module for retrieving a first user interface specification, said first user interface specification specifying a first data format;

a peripheral device substitution control module in communication with the data retrieval module for receiving information from the user according to a second data format;

the peripheral device substitution control module being adapted to send data received in the second data format to the data receiving server in the first data format.

In this specifications, a data retrieval module referrers to any and all interfaces designed to communicate with the Internet, and more specifically to interpret HTTP or similarly arranged interface defining protocols such as HTTPS, XML, HTML, DHTML, JAVA®, VB®, and other such protocols as to be developed for defining and creating a user interface. While the most common example of such data retrieval module is a common web browser, other such internet access module examples are agents that interpret the protocols and act thereupon to display, modify, or send and receive information, are considered to fall within the invention. Thus in a preferable implementation, the self-service kiosk comprises a web browser, the data retrieval module comprising the web browser, the first user interface specification comprising a web page and the first data format comprising a web form.

The self-service kiosk of the present invention can therefore use a peripheral provided on a self-service kiosk, for example a card reader, to read identifying information and submit this information to a server in the same format as would have taken place if corresponding information had been entered by a different input means not provided on the self-service kiosk, for example a keyboard. Therefore, the present invention provides an improved way to deliver web commerce through self-service kiosks lacking peripherals such as keyboards.

According to a second aspect of the present invention there is provided a method of submitting data to a data receiving server in a data format, for execution on a self-service kiosk, the method comprising the steps of:

retrieving a first user interface specification, said first user interface specification comprising a first data format;

inputting information from a user according to a second data format;

submitting said information to the data receiving server in the first data format.

### BRIEF DESCRIPTION OF THE DRAWINGS

An example embodiment of the present invention will now be illustrated with reference to the following drawings in which:

FIG. 1 is a schematic diagram of a self-service kiosk according to the present invention;

FIG. 2 is an example web page;

FIG. 3 is the HTML corresponding to the web page of FIG. 2;

FIG. 4 is a block diagram of the key components of the self-service kiosk CPU;

FIG. 5 is a flow chart of the process used to complete and submit a web form;

FIG. 6 is an HTML listing for an agent web page; and

FIG. 7 is example data submitted to a server.

### DETAILED DESCRIPTION OF THE PREFERRED EMBODIMENT

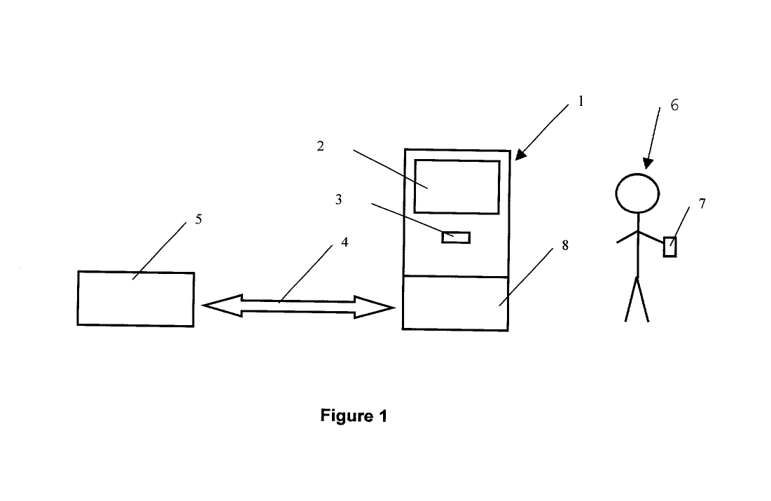

FIG. 1 illustrates a computerised self-service kiosk 1 having a touch screen 2 and user identification device reader 3. Self-service kiosk 1 is connected to the internet 4 to enable it to communicate with a plurality of remote servers 5 using HTTP or a similar protocol such as secure HTTP (HTTPS). Self-service kiosk 1 presents web pages delivered by the server 5 to a user 6. To use the self-service kiosk I the user requires a user identification device 7. Preferred user identification devices 7 are a credit card, debit card or smart card. The self-service kiosk is controlled by a computer 8. When a user 6 interacts with a self-service kiosk 1 they can access the internet and use user interface peripherals provided on the self-service kiosk 1, for example, the touch screen 2.

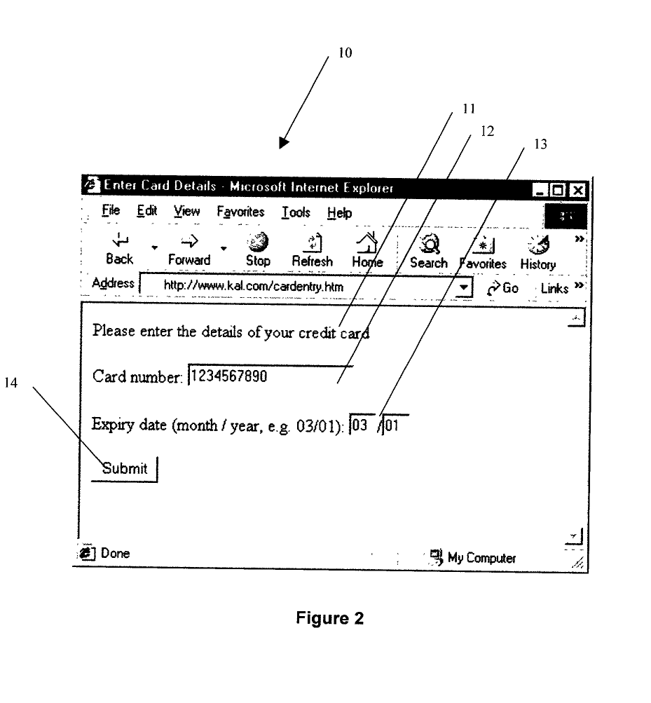

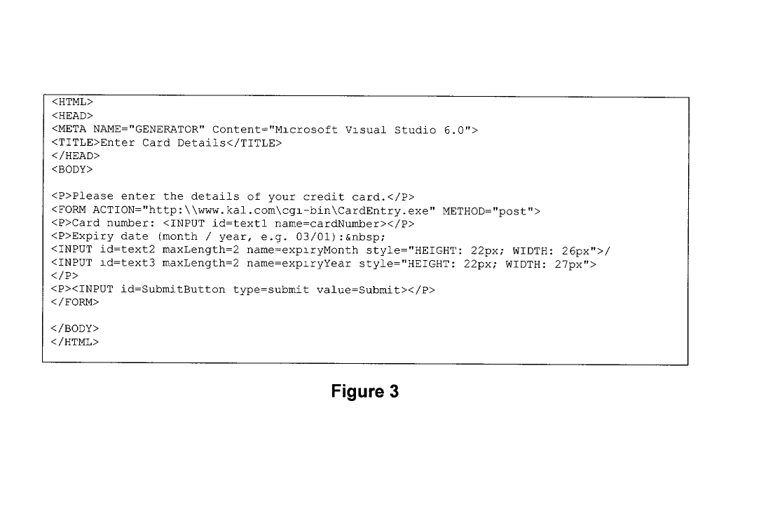

FIG. 2 illustrates an example of an e-commerce web page 10. Web page 10 contains an invitation to pay 11. This includes a request for the user to enter a credit card number 12 and to indicate the expiry date of their credit card 13. A button 14 is used to confirm the purchase. This example web page is a form having three fields for entry and submission to the server: card number, expiry month and expiry year. FIG. 3 is the HTML source for the web page shown in FIG. 2. Instead of HTML, other internet standards and markup languages can readily be used; for example, DHTML or XML. Typically, a server 5 will analyse the submitted form data using CGI, Active Server Pages, Java Server Pages or similar protocols.

However, like many other kiosks, self-service kiosk 1 does not have a conventional keyboard. It is not desirable to provide conventional keyboards on kiosks to be used in the public arena due to the risk of vandalism. Also, keyboards are perceived as difficult to use by those who are not familiar with them and sometimes provide access to undesirable operating system functions through key combinations such as CTRL-ALT-DEL.

Self-service kiosk 1 enables a user to instead complete the form 10 and submit it to remote server 5 simply by inserting user identification device 7 into user identifying device reader 3. When this takes place, the self-service kiosk 1 accesses the required information from the identification device 7, converts it into the appropriate format and submits the same information to remote server 5 as would have been submitted had the user completed elements of the form 10 using a keyboard and mouse on a conventional PC. As a result, the web page 10 need not be customised to function on self-service kiosk 1. Indeed this means that self-service kiosk 1 can provide a method to pay for the product without any work or indeed co-operation by the owner of the server 5.

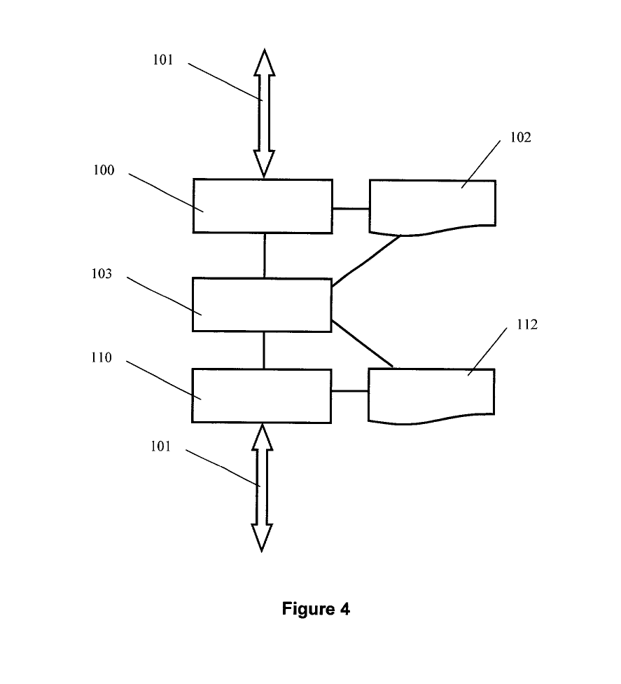

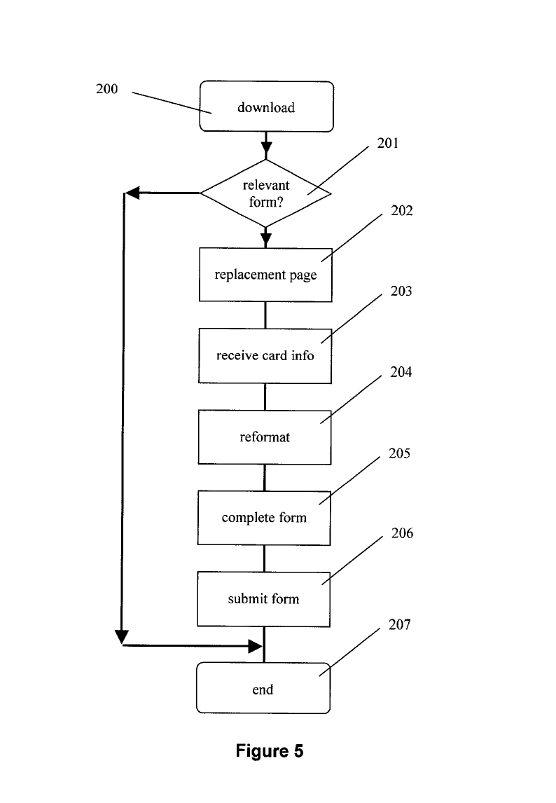

FIG. 4 illustrates the components of the controlling computer 8 which enable the invention to be carried out. FIG. 5 is a flow chart of steps in an example process carried out by the self-service kiosk in response to navigation to a web page containing a relevant form. The internet is accessible to browser module 100, which may be an Internet Explorer® component provided by Microsoft® of Redmond, Wash. Browser module 100 has access to the internet through interface 101; therefore, the browser module 100 can make requests in HTTP or similar protocols to remote servers 5 and retrieve web pages following user requests.

With reference to FIG. 4, browser module 100 accesses the internet 101 to retrieve web pages 102 for display. A peripheral device substitution control module 103 is provided to check the content and/or URL of retrieved web pages 102 to establish whether they contain a form which should be completed by the method of the present invention, whereupon another browser window, here represented by a separate browser component 110, executes an alternate web page 112 that provides functionality for completing the web form 102. Although a separate browser component 110 is shown, a different window displayed by the same browser component is another option.

With reference to the flow chart in FIG. 5, peripheral device substitution control module 103 is activated responsive to retrieval of a web page 200. The content and/or URL of each retrieved web page 102 is checked 201 to see whether it comprises a form which should be completed using the method of the present invention. If so, a replacement web page 112 is retrieved 202 and executed. The replacement web page 112 is displayed on top of the retrieved web page 102 in another browser window. Web form completion module 103 can establish whether there is a form present. Preferably, form detection is achieved by comparing the URL with one or more specified URLs, known to contain forms. Other options include detecting a particular metatag within the web page 102, searching the retrieved web page 102 for the HTML, “type=submit” or using an algorithm designed to infer whether the page contains a request for information of a particular type (e.g. credit card information) from the names and types of fields present in the form.

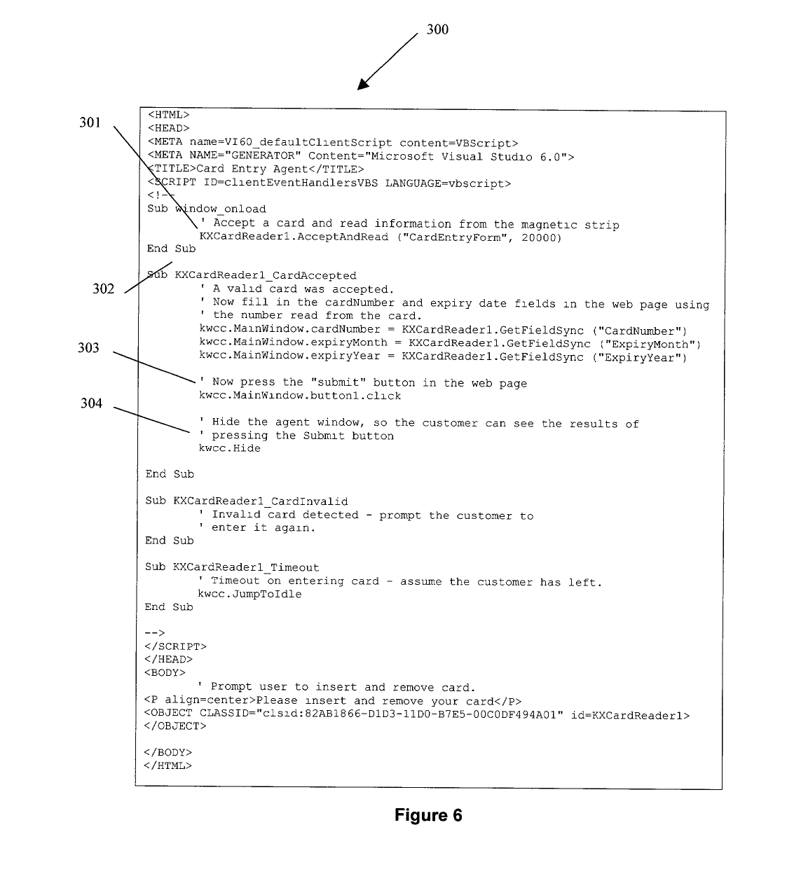

FIG. 6 lists the HTML code for a replacement web page 112 according to the preferred embodiment which, when executed, implements the input device substitution. FIG. 6 illustrates an example agent page containing HTML and VB script. This replacement web page 112 is then executed by the browser module 100. The web page begins by initialising the card reader by calling the an appropriate software method. In the preferred embodiment, this is the AcceptAndRead method of the Kalignite® card reader control kxcardreader1 available from KAL of Edinburgh, Scotland. The Kalignite® card reader control can be used with any card reader that has an XFS or OPOS interface. Other embodiments of the invention can use other software methods for controlling the card reader device and one skilled in the art can readily devise a control adapted to read information from a specified peripheral and return said information in an appropriate format. The HTML 300 corresponding to replacement web page 112 provides a visual prompt to a user and the method KXCardReader1.AcceptAndRead instructs the card reader to accept a card and read information from the magnetic strip, storing the read information in an appropriate data format. The page then reacts to events generated by this card reader control. If a card accepted event occurs this means that a valid card has been entered. The card reader control 301 automatically parses the data read from the card into named fields, such as card number, expiry month and expiry year. There after, a card accepted event handling routine 302 selects the named fields from the card data and inserts them into the corresponding HTML form field in the e-commerce web page 10. The HTML form is then submitted by invoking a click method on the submit button 303. The replacement web page window is then hidden so that the customer can see the results of pressing the submit button. The resulting effect is the same as if a customer had entered their card details manually using an alphanumeric keyboard and had themselves clicked on the submit button.

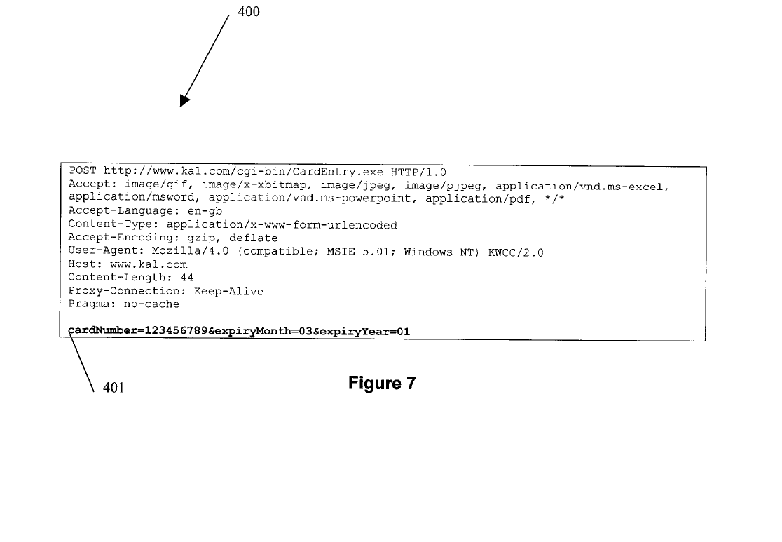

FIG. 7 lists an example of a data format for sending to a server, specifically FIG. 7 is the data submitted by a user on completion of the form in e-commerce web page 10. Submitted form data 400 includes a string 401 consisting of “field name =data” pairs providing the information specified in the form to the remote server 5 and the same data is provided by the method of the present invention.

As well as using keyboard input, users might also identify themselves with a mouse, cards having magnetic strips (including debit, credit, loyalty, gift or identification cards), smart cards, Bluetooth® enabled device or mobile phones, other chip-based identification devices, for example iButtons™ available from Maxim Integrated Products of Sunnyvale, Calif., and also from cheques containing account information. Readers are known for each of these types of user identification devices and the invention enables these identification device readers to be used instead of keyboards.

In a further embodiment, the information may not all be provided on the identification device but, instead, the self-service kiosk may acquire information from another location, such as a bank server, and submit that information. For example, a user might swipe their card through a card reader from which their card information is read, but the card may not have the user's address. This can be acquired from another remote server by means of an HTTP request and this information can also be included when the retrieved web page 102 form is completed. In this embodiment, many types of input device connected to the computer can be used to read relevant information identifying the user 6, for example, a fingerprint, iris or cornea identification device, a camera or a finger print reader.

An appropriate parsing routine can be written by one skilled in the art specific to the particular data format used by a card reader or other identification device. For example, the format may correspond to “American National Standard for Identification Cards Financial Transaction Cards, ANSI/ISO/IEC 7813-1995” or EMV smart card format, available from www.emvco.com. Other standards exist for reading optical character recognition information and magnetic ink information. Unparsing is preferably carried out by use of an XFS form which specifies how to the read the data from a card or other identification device into different fields and this XFS form then configure the card reader control. Equivalent components, such as in the OPOS standard are known which perform similar unparsing functions. Alternatively the raw data can be read from the card, and another piece of custom code may carry out the unparsing. This code could be another component called

from the HTML page, or even the script on the page itself. In another embodiment the entire application is written in C++. Custom parsing or unparsing routines may be written for specific sites. A more general system might apply heuristics to the web form, looking for field names such as “account” or “expirymonth” and thereby establishing the correct format for completing a form.

The invention can generally be applied to enable information received through one user interface to be provided to a server in the same format as it would have been had that information been provided in completion of a web form using a different interface. For example, a keyboard could be provided to enter numerical information which is normally read by a card reader, allowing a home PC user to access web commerce facilities designed primarily for use through kiosks and ATMs having specialised hardware, such as card readers. Conversely, ATM applications requiring input devices usually only found on ATMs, for example, credit card readers and pen pads, can be delivered through PCs by enabling the PC to present an alternate user interface, such as, a web page containing a web form through which a user can enter details.

The invention is most beneficial when the input device is different to that for which the web form was intended, although the invention can be used as a convenient way for enabling only a single user interface specification to be written, which can be replaced with different interfaces on different computers by providing different replacement web pages 112 for each.

Instead of providing a replacement web page 112, the execution of which causes the retrieved web page 102 form to be completed and submitted, a software program in any computer language may carry out the necessary function. For example, a dialog written in C++. Alternatively, the retrieved web page may be edited to add a call to a card reader control and the other event responsive functionality required to implement the invention. Data 400 may be submitted to remote server 5 not just by entering the information received from a card reader in the browser window managing the retrieved web page 102 and causing the browser 100 to submit the information, but by otherwise preparing the same data 400 that the browser component 100 would transmit to the server 5 in response to submission of the form and sending it separately by HTTP across the internet 101 without recourse to the browser component 100.

The replacement web page 112 may be stored locally or remotely, it may be created from a template when required. A particular replacement web page 112 may be specified for particular web sites and site identifying data may be stored on the kiosk specifying particular web page addresses and corresponding replacement web page 112 addresses for use with the specified web page addresses.

A further example of an appropriate reader and peripheral would be a smart card reader provided by Pocket server™ from Touch Technology International of Phoenix, Ariz. (www.pocketserver.com) or an electronic cash card reader. Examples include the KD Electronics CIM4900, the Mag-Tek MT215, and the Omron 3S4YR-MVFW.

In general the invention is applicable not just with a web form but with any type of retrieved user interface specification which specifies a format for transmitting data to a server. Although use of a web browser is preferred, the technology is applicable wherever any type of data retrieval module is used to retrieve a user interface specification specifying a data format. Typically, the user interface specification is a web page in HTML, DHTML or XML and contains graphics, text and layout information as well as specifying a data format by way of a form. More generally, user interface specifications can be retrieved from any source, including a local storage device; however, they are preferably downloaded from a server across a network.

The invention can be implemented by customising any web browser, or alternatively may be implemented using a separate component architecture containing a web browser.

The invention extends to computer programs in the form of source code, object code, code intermediate sources and object code (such as in a partially compiled form), or in any other form suitable for use in the implementation of the invention. Computer programs may be standalone applications, software components or plug-ins to other applications. Computer programs may be web pages. Computer programs may be embodied on a carrier, being any entity or device capable of carrying the computer program: for example, a storage medium such as ROM or RAM, optical recording media such as CD-ROM or magnetic recording media such as floppy discs. The carrier may be a transmissible carrier such as an electrical or optical signal conveyed by electrical or optical cable, or by radio or other means. Computer programs may be provided for retrieval across the internet from a server. Computer programs may also be embedded in an integrated circuit.

Other modifications and alterations can be made within the scope of the invention herein disclosed.

What is claimed is:

1. A self-service kiosk adapted to submit data to a data receiving server in a data format, the system comprising:
a data retrieval module for retrieving a first user interface specification, said first user interface specification specifying a first data format;
a peripheral device substitution control module in communication with the data retrieval module for causing information to be received from the user according to a second data format;
the peripheral device substitution control module being adapted to send data received in the second data format to the data receiving server in the first data format.

2. The self-service kiosk of claim 1 comprising a web browser, the web browser comprising the data retrieval module, the first user interface specification comprising a web page.

3. The self-service kiosk of claim 2 wherein the first data format comprises a web form.

4. The self-service kiosk of claim 3 wherein the peripheral device substitution control module is adapted to retrieve a second web page.

5. The self-service kiosk of claim 4 wherein a second web page specifies visual images to be displayed instead of the first user interface specification.

6. The self-service kiosk of claim 4 wherein a second web page specifies the second data format.

7. The self-service kiosk of claim 6 wherein information received in the second data format is filled in, by the self-service kiosk, to the web form and submitted to the server by the web browser.

8. The self-service kiosk of claim 2 comprising information identifying at least one web page or group of web pages, wherein the peripheral device substitution control module is adapted to respond to the data retrieval module and present a user interface to a user when an identified web pages is accessed.

9. The self-service kiosk of claim 1 wherein the peripheral device substitution control module is adapted to create the second user interface specification by altering the first user interface specification.

10. The self-service kiosk of claim 1 wherein the first user interface specification specifies a format for receiving data from one peripheral and the second user interface specification specifies a format for receiving data from a second peripheral.

11. The self-service kiosk of claim 1 wherein the data format comprises alphanumeric information and the peripheral device substitution control module is adapted to input information from a user identification device.

12. The self-service kiosk of claim 11 where the peripheral device substitution control module is adapted to input information from a credit card reader, debit card reader or smart card reader.

13. The self-service kiosk of claim 1 wherein the first user interface specification comprises a request for information to be input through a user identification device reader and the peripheral device substitution control module is adapted to read information from a keyboard and then convert it into the data format.

14. A method of submitting data to a data receiving server in a data format, for execution on a self-service kiosk, the method comprising the steps of:
retrieving a first user interface specification, said first user interface specification comprising a first data format;
inputting information from a user according to a second user interface specification;
submitting said information inputted according to a second user interface specification to the data receiving server in the first data format.

15. The method of claim 14 comprising a web browser, the web browser comprising the data retrieval module, the first user interface specification comprising a web page.

16. The method of claim 15 wherein the first data format comprises a web form.

17. The method of claim 16 wherein the peripheral device substitution control module is adapted to retrieve a second web page, said second web page comprising the second user interface specification.

18 The method of claim 17 wherein a second web page specifies visual images to be displayed instead of the first user interface specification.

19. The method of claim 17 wherein a second web page specifies the second data format.

20. The method of claim 16 wherein information received in the second data format is filled in, by the self-service kiosk, to the web form and submitted to the server by the web browser.

21. The method of claim 15 comprising information identifying at least one web page or group of web pages, wherein the peripheral device substitution control module is adapted to respond to the data retrieval module and present a user interface to a user when an identified web page is accessed.

22. The method of claim 14 wherein the peripheral device substitution control moduleis adapted to create the second user interface specification by altering the first user interface specification.

23. The method of claim 14 wherein the first user interface specification specifies a format for receiving data from one peripheral and the second user interface specification specifies a format for receiving data from a second peripheral.

24. The method of claim 14 wherein the data format comprises alphanumeric information and the peripheral device substitution control module is adapted to input information from a peripheral other than a keyboard.

25. The method of claim 24 where the peripheral device substitution control module is adapted to input information from a credit card reader, debit card reader or smart card reader.

26. The method of claim 14 wherein the first user interface specification comprises a request for information to be input through a user identifier peripheral and the peripheral device substitution control module is adapted to read information from a keyboard and then convert it into the data format.

27. Computer software comprising program code which, when loaded into a computer, causes it to perform as the self-service kiosk of claim 1.

28. Computer software comprising program code which, when loaded into a computer, causes said computer to perform the method of claim 14.

29. A method of submitting a web form to a web server from a self-service kiosk responsive to user actions, the method comprising the steps of:
causing a web browser to retrieve a first web page, said first web page comprising a web form suitable for completion with a keyboard and comprising at least one field requiring alphanumeric information;
said web form specifying a format in which user input information is to be sent to the web server;
responsive to retrieval of a web page comprising a web form, executing a peripheral device substitution control module adapted to read information from a user identifier peripheral and to transmit to the web server information in the format specified by said web form.

30. A method of submitting a web form to a web server from a self-service kiosk responsive to user actions, the method comprising the steps of:
causing a web browser to retrieve a first web page, said first web page comprising a web form suitable for completion with a keyboard and comprising at least one field requiring alphanumeric information;
said web form specifying a format in which user input information is to be sent to said web server;
responsive to retrieval of a web page comprising a web form, retrieving and executing a second web page;
said second web page comprising instructions which, when executed, cause said self-service kiosk to input information from a user identification device using a user identification device reader, to complete said web form in said web browser using said inputted information and then to cause said web browser to send said completed web form to said server.
